(19) United States
(12) Patent Application Publication
(10) Pub. No.: US 2007/0221162 A1
(43) Pub. Date: Sep. 27, 2007

(54) High-Pressure Pump for a Fuel Injection System of an Internal Combustion Engine

(76) Inventors: Achim Koehler, Ditzingen (DE); Sascha Ambrock, Fachbach (DE)

Correspondence Address: RONALD E. GREIGG;GREIGG & GREIGG P.L.L.C., 1423 POWHATAN STREET, UNIT ONE, ALEXANDRIA, VA, 22314, US

(21) Appl. No.: 11/597,326

(22) PCT Filed: Apr. 18, 2005
(86) PCT No.: PCT/EP05/51692

§ 371 Date: Nov. 22, 2006

(30) Foreign Application Priority Data
Jun. 16, 2004 (DE) 10 2004 028 998.0

(51) Int. Cl. F02B 57/02

(52) U.S. Cl. 123/206

(57) ABSTRACT

The high-pressure pump has at least one pump element with a pump piston driven in a reciprocating motion and defining a pump work chamber into which fuel is aspirated from a fuel inlet via an inlet valve in the intake stroke and from which fuel is positively displaced in the pumping stroke. The inlet valve has a valve member which with a sealing face cooperates with a valve seat for controlling the communication of the pump work chamber with the fuel inlet. The sealing face of the valve member has two portions with first and second cone angles that are different from one another. The seat face has a constant, third cone angle that is different from the first and second cone angles. At the transition between the two portions of the sealing face, a protruding edge is formed, with which the sealing face comes to rest on the seat face with the constant cone angle.

### PRIOR ART

The invention is based on a high-pressure pump for a fuel injection system of an internal combustion engine as generically defined by the preamble to claim 1.

One such high-pressure pump is known from German Patent Disclosure DE 198 60 672 A1. This high-pressure pump has at least one pump element, with a pump piston that is driven to a reciprocating motion and that defines a pump work chamber. In the intake stroke of the pump piston, via an inlet valve, fuel is aspirated from the fuel inlet, and in the pumping stroke of the pump piston, via an outlet valve, fuel is positively displaced out of the pump work chamber into a high-pressure region. The inlet valve has a valve member with a sealing face, with which it cooperates with a valve seat for controlling the communication of the pump work chamber with the fuel inlet. The sealing face and the seat face of the valve seat are each embodied frustoconically but have different cone angles. The valve member is urged in the closing direction by the pressure prevailing in the pump work chamber and in the opening direction by the pressure prevailing in the fuel inlet. In the known high-pressure pump, a linear contact occurs between the sealing face of the valve member and the seat face of the valve seat; over the service life of the high-pressure pump, because of wear, the location of this linear contact varies, which causes a change in the opening pressure of the inlet valve, since the size of the surface area of the valve member acted upon by the pressure in the fuel inlet varies. As a result, filling of the pump work chamber with fuel becomes worse and the pumping characteristic of the high-pressure pump is impaired.

### ADVANTAGES OF THE INVENTION

The high-pressure pump of the invention having the characteristics of claim 1 has the advantage over the prior art that the opening pressure of the inlet valve changes only slightly over the service life of the high-pressure pump, and therefore the pumping characteristic of the high-pressure pump also remains at least essentially the same over the service life.

In the dependent claims, advantageous embodiments and refinements of the high-pressure pump of the invention are disclosed.

### DRAWING

Two exemplary embodiments of the invention are shown in the drawing and described in further detail in the ensuing description.

FIG. 1 shows a high-pressure pump for a fuel injection system of an internal combustion engine;

FIG. 2 shows an inlet valve of the high-pressure pump in an enlarged longitudinal section in accordance with a first exemplary embodiment; and

FIG. 3 shows the inlet valve in accordance with a second exemplary embodiment.

### DESCRIPTION OF THE EXEMPLARY EMBODIMENTS

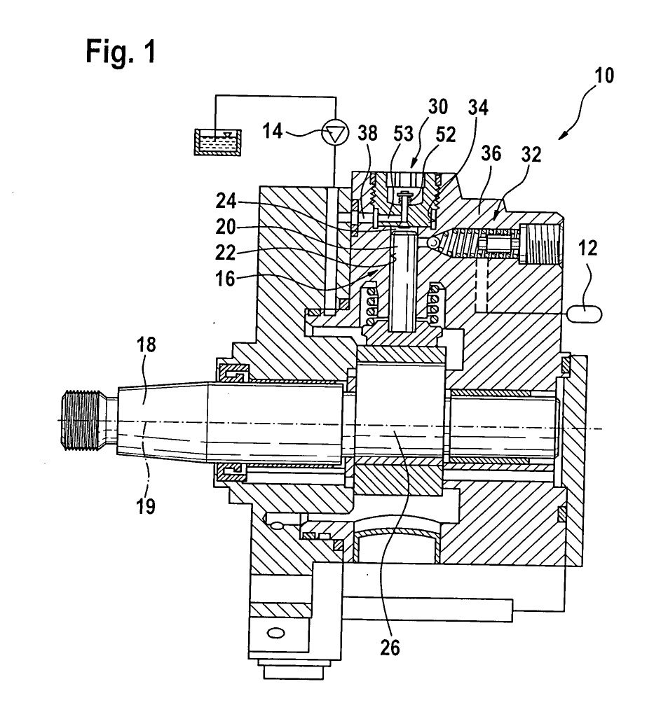

In FIG. 1, a high-pressure pump 10 is shown for a fuel injection system of an internal combustion engine, which is preferably a self-igniting internal combustion engine. By means of the high-pressure pump 10, fuel is pumped at high pressure into a reservoir 12, from which fuel is withdrawn for injection into the engine. The high-pressure pump 10 is supplied with fuel by a feed pump 14. The high-pressure pump 10 has at least one pump element 16, which has a pump piston 20 that is driven in a reciprocating motion at least indirectly by a drive shaft 18 of the high-pressure pump 10. The pump piston 20 is guided tightly in a cylindrical bore 22 extending at least approximately radially to the drive shaft 18 and defines a pump work chamber 24 in the outer end region, facing away from the drive shaft 18, of the cylindrical bore 22. The drive shaft 18 has a cam, or a shaft portion 26 eccentric to its axis of rotation 19, by way of which the reciprocating motion of the pump piston 20 is effected upon the rotary motion of the drive shaft 18. The pump work chamber 24 can be made to communicate with a fuel inlet from the direction of the feed pump 14, via an inlet valve 30 that opens into the pump work chamber 24 and is embodied as a check valve. The pump work chamber 24 can also be made to communicate with a fuel outlet to the reservoir 12, via an outlet valve 32 opening out of the pump work chamber 24 and embodied as a check valve. In the intake stroke, the pump piston 20 moves radially inward in the cylindrical bore 22, so that the volume of the pump work chamber 24 is increased. In the intake stroke of the pump piston 20, because of the pressure difference existing then, the inlet valve 30 is opened, since a higher pressure is generated by the feed pump 14 than the pressure that prevails in the pump work chamber 24, and so the fuel pumped by the feed pump 14 is aspirated into the pump work chamber 24. The outlet valve 32 is closed upon the intake stroke of the pump piston 20, since a higher pressure prevails in the reservoir 12 than in the pump work chamber 24.

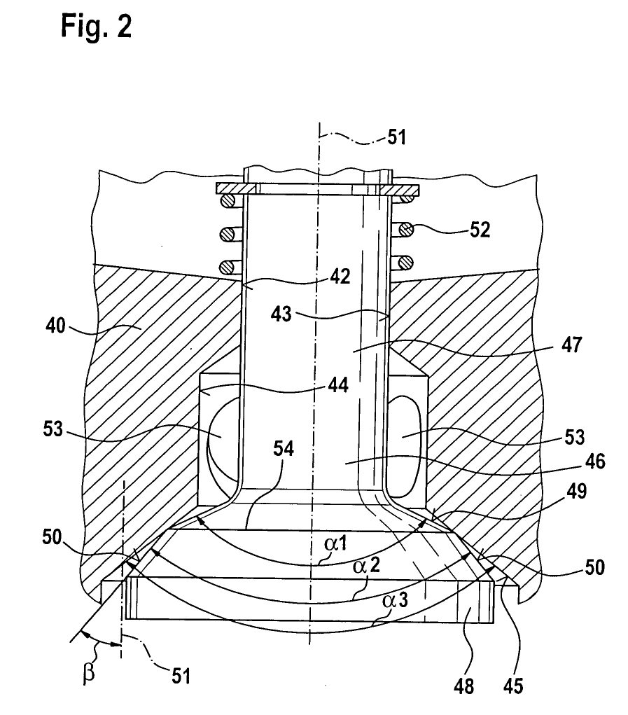

The inlet valve 30 will now be described in greater detail in conjunction with FIG. 2, in which the inlet valve 30 is shown in a first exemplary embodiment. The inlet valve 30 is inserted for instance into a bore 34, radially adjoining the cylindrical bore 22 on the outside, of a housing part 36 of the high-pressure pump 10. The bore 34 is embodied with a larger diameter than the cylindrical bore 22. The housing part 36 may for instance be a cylinder head communicating in which the drive shaft 18 is supported, or it may be a housing part in which the drive shaft 18 is also supported. A fuel inlet conduit 38, which communicates with the feed pump 14, discharges into the bore 34, for instance approximately radially to the axis of the bore 34, near its end region oriented toward the cylindrical bore 22. The inlet valve 30 has a valve housing 40, in which there is a bore 42 of graduated diameter. The bore 42 has one portion 43 of small diameter, one portion 44 of larger diameter adjoining the portion 43 toward the pump work chamber 24, and one portion 45 adjoining the portion 44 toward the pump work chamber 24. The inlet valve 30 has a piston-shaped valve member 46, which is guided displaceably with a cylindrical shaft 47 in the bore portion 43. The valve member 46 also has a head 48, adjoining the shaft 47 and having a larger diameter than the shaft 47, and there is a sealing face 49, 50 on the valve member 46 at the transition from the head 48 to the shaft 47. The sealing face has two portions 49, 50, located successively in the direction of the longitudinal axis 51 of the valve member 44, which are each embodied at least approximately conically, but which have different cone angles from one another. The first portion 49 of the sealing face, facing away from the pump work chamber 24, has a cone angle α1, and the second portion 50 of the sealing face, facing toward and adjoining the pump work chamber 24, has a cone angle α2, which is smaller than the cone angle α1. The head 48 of the valve member 46 points toward the pump work chamber 24. The shaft 47 of the valve member 46, with its end remote from the head 48, protrudes out of the bore portion 43 and is engaged there by a prestressed closing spring 52.

At least one inlet conduit 53 is made in the valve housing 40 and discharges into the bore portion 44. Preferably, a plurality of inlet conduits 53, for instance three of them, are provided, distributed uniformly over the circumference of the valve housing 40. The bore portion 45 is embodied such that its diameter increases from the bore portion 44 toward the pump work chamber 24. The jacket face of the bore portion 45 forms a seat face of a valve seat, is embodied at least approximately conically, and has a constant cone angle α3. The cone angle α3 is larger than the cone angle α2, but smaller than the cone angle α1. At the transition between the first portion 49 and the second portion 50 of the sealing face, an edge 54 protruding toward the seat face 45 is formed on the valve member, and with this edge the valve member 46, in its closing position, comes into contact with the seat face 45; as a result, the pump work chamber 24 is disconnected from the fuel inlet having the inlet conduits 53. The two portions 49, 50 of the sealing face of the valve member 46 form an obtuse angle. The difference Δα between the cone angle α1 of the portion 49 of the sealing face at the valve member 46 and the cone angle α3 of the seat face 45 is preferably between approximately 0.1° and 20°. The difference Δα between the cone angle α2 of the portion 50 of the sealing face at the valve member 46 and the cone angle α3 of the seat face 45 is preferably between approximately 0.1° and 90°. The angle β between the second portion 50 of the sealing face of the valve member 46 and the longitudinal axis 51 of the valve member 46 is greater than 0° and less than 90°.

The face of the first portion 49 of the sealing face of the valve member 46, located inside the edge 54, is acted upon by the pressure prevailing in the fuel inlet 38, 53, by which a force in the opening direction on the valve member 46 is generated. The end face, toward the pump work chamber 24, of the head 48 of the valve member 46 is acted upon by the pressure prevailing in the pump work chamber 24, by which a force in the closing direction on the valve member 46 is generated. Moreover, the closing spring 52 generates a force in the closing direction on the valve member 46. During the service life of the high-pressure pump, the edge 54 becomes pressed somewhat flat because of wear, and the area of the face of the first portion 49 of the sealing face of the valve member 46 acted upon by the pressure prevailing in the fuel inlet decreases slightly as a result, so that the opening pressure, which is the pressure difference between the pressure prevailing in the fuel inlet and the pressure prevailing in the pump work chamber 24, at which the inlet valve 30 opens increases slightly.

In the intake stroke of the pump piston 20, the inlet valve 30 opens when the force in the opening direction on the valve member 46, generated by the pressure prevailing in the fuel inlet 38, 51 and acting on the portion 49 of the sealing face of the valve member 46, is greater than the sum of the force generated on the valve member 46 by the pressure prevailing in the pump work chamber 24 and the force generated by the closing spring 52. In the pumping stroke of the pump piston 20, the pump piston generates an increased pressure in the pump work chamber 24, and as a result the inlet valve 30 is closed.

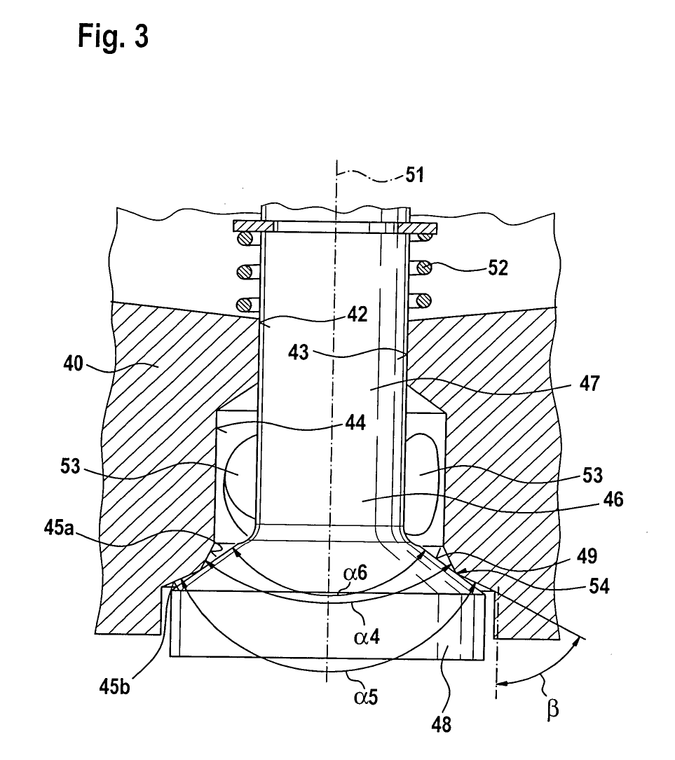

In FIG. 3, the inlet valve 30 is shown in a second exemplary embodiment. The inlet valve 30 here has the valve housing 40, in which the bore 42 with the portions 43, 44 and 45 is embodied. In a distinction from the first exemplary embodiment, the bore portion 45 that forms the seat face of the valve seat does not have a constant cone angle; instead, it has a first portion 45a with a cone angle α4 and a second portion 45b with a cone angle α5. The cone angle α5 of the second portion 45b is larger than the cone angle α4 of the first portion 45a. The valve member 46 has the shaft 47, guided in the portion 43 of the bore 42, and the head 48 pointing toward the pump work chamber 24; the conical sealing face 49, which has a constant cone angle α6, is located at the transition from the shaft 47 to the head 48. The cone angle α4 of the first portion 45a of the seat face is smaller than the cone angle α6 of the sealing face 49 of the valve member 46, and the cone angle α5 of the second portion 45b of the seat face is larger than the cone angle α6 of the sealing face 49 of the valve member 46. The difference Δα between the cone angle α4 of the first portion 45a of the seat face and the cone angle α6 of the sealing face 49 of the valve member 46 is preferably between approximately 0.1° and 90°. The difference Δα between the cone angle α5 of the second portion 45b of the seat face and the cone angle α6 of the sealing face 49 of the valve member 46 is preferably between approximately 0.1° and 20°. The angle β between the second portion 45b of the seat face and the longitudinal axis 51 of the valve member 46 is greater than 0° and less than 90°. At the transition between the two portions 45a, 45b of the seat face, a protruding edge 54 is formed, with which the valve member 46 comes into contact with its sealing face 49 in its closing position.

1-7. (canceled)

8. A high-pressure pump for a fuel injection system of an internal combustion engine, the pump comprising
at least one pump element, which has a pump piston, driven in a reciprocating motion and defining a pump work chamber into which, upon the intake stroke of the pump piston, fuel from a fuel inlet is aspirated via an inlet valve and from which, in the pumping stroke of the pump piston, fuel is positively displaced into a high-pressure region,
the inlet valve having a valve member, which with a sealing face cooperates with a valve seat for controlling the communication of the pump work chamber with the fuel inlet,
the valve member being urged in the opening direction by the pressure prevailing in the fuel inlet and in the closing direction by the pressure prevailing in the pump work chamber,
the sealing face of the valve member and the seat face of the valve seat each being embodied at least approximately conically,
the sealing face of the valve member, or the seat face of the valve seat, having two portions with first and second cone angles that differ from one another,
the other of said seat face or sealing face having a constant, third cone angle that differs from the first and second cone angle; and
a protruding edge formed at the transition between the two portions on which edge the face having the constant cone angle comes to rest.

9. The high-pressure pump in accordance with claim 8, wherein the difference between the first and second cone angles and the third cone angle is between approximately 0.1° and 90°.

10. The high-pressure pump in accordance with claim 9, wherein the difference between the first and second cone angles and the third cone angle is between about 0.1° and 20°.

11. The high-pressure pump in accordance with claim 8, wherein the two portions having the cone angles different from one another are located on the sealing face of the valve member; wherein the first portion is oriented toward the fuel inlet and has the first cone angle; and wherein the second portion is oriented toward the pump work chamber and has the second cone angle, which is smaller than the first cone angle.

12. The high-pressure pump in accordance with claim 10, wherein the two portions having the cone angles different from one another are located on the sealing face of the valve member; wherein the first portion is oriented toward the fuel inlet and has the first cone angle; and wherein the second portion is oriented toward the pump work chamber and has the second cone angle, which is smaller than the first cone angle.

13. The high-pressure pump in accordance with claim 11, wherein the first cone angle of the first portion of the sealing face of the valve member is larger than the constant, third cone angle of the seat face; and that the second cone angle of the second portion of the sealing face of the valve member is smaller than the constant, third cone angle of the seat face.

14. The high-pressure pump in accordance with claim 12, wherein the first cone angle of the first portion of the sealing face of the valve member is larger than the constant, third cone angle of the seat face; and that the second cone angle of the second portion of the sealing face of the valve member is smaller than the constant, third cone angle of the seat face.

15. The high-pressure pump in accordance with claim 8, wherein the two portions having cone angles different from one another are located on the seat face; wherein the first portion is oriented toward the fuel inlet and has the first cone angle; and wherein the second portion is oriented toward the pump work chamber and has the second cone angle, which is larger than the first cone angle.

16. The high-pressure pump in accordance with claim 9, wherein the two portions having cone angles different from one another are located on the seat face; wherein the first portion is oriented toward the fuel inlet and has the first cone angle; and wherein the second portion is oriented toward the pump work chamber and has the second cone angle, which is larger than the first cone angle.

17. The high-pressure pump in accordance with claim 10, wherein the two portions having cone angles different from one another are located on the seat face; wherein the first portion is oriented toward the fuel inlet and has the first cone angle; and wherein the second portion is oriented toward the pump work chamber and has the second cone angle, which is larger than the first cone angle.

18. The high-pressure pump in accordance with claim 15, wherein the first cone angle of the first portion of the seat face is smaller than the constant, third cone angle of the sealing face of the valve member; and wherein the second cone angle of the second portion of the seat face is larger than the constant, third cone angle of the sealing face of the valve member.

19. The high-pressure pump in accordance with claim 17, wherein the first cone angle of the first portion of the seat face is smaller than the constant, third cone angle of the sealing face of the valve member; and wherein the second cone angle of the second portion of the seat face is larger than the constant, third cone angle of the sealing face of the valve member.

20. The high-pressure pump in accordance with claim 8, wherein the valve member is embodied at least approximately spherically; and wherein the sealing face is formed by a region of the surface of the valve member.

21. The high-pressure pump in accordance with claim 9, wherein the valve member is embodied at least approximately spherically; and wherein the sealing face is formed by a region of the surface of the valve member.

22. The high-pressure pump in accordance with claim 10, wherein the valve member is embodied at least approximately spherically; and wherein the sealing face is formed by a region of the surface of the valve member.

23. The high-pressure pump in accordance with claim 11, wherein the valve member is embodied at least approximately spherically; and wherein the sealing face is formed by a region of the surface of the valve member.

24. The high-pressure pump in accordance with claim 12, wherein the valve member is embodied at least approximately spherically; and wherein the sealing face is formed by a region of the surface of the valve member.
